(19) United States
(12) Patent Application Publication
(10) Pub. No.: US 2021/0333338 A1
(43) Pub. Date: Oct. 28, 2021

(54) METHOD FOR EVALUATING ULTIMATE DEMAGNETIZATION TEMPERATURE OF MAGNET

(71) Applicant: TYMPHANY ACOUSTIC TECHNOLOGY (HUIZHOU) CO., LTD., Huizhou City (CN)

(72) Inventor: Zhiwen CHEN, Huizhou City (CN)

(21) Appl. No.: 17/368,318

(22) Filed: Jul. 6, 2021

Related U.S. Application Data
(63) Continuation-in-part of application No. 16/100,838, filed on Aug. 10, 2018.

(30) Foreign Application Priority Data
Aug. 10, 2017 (CN) 201710681056.1

(51) Int. Cl. G01R 33/16; G06F 30/23

(52) U.S. Cl. CPC G01R 33/16; G06F 30/23

(57) ABSTRACT

A method for evaluating ultimate demagnetization temperature of magnet includes displaying a workspace interface. The workspace interface at least includes an operation area, a model view displaying area, and a demagnetization curve displaying area. A geometric model view of a geometric model file to be solved is displayed in the model view displaying area. Information input is received through the operation area and the model view displaying area, and performance parameters and designing variables to be solved and formulas are imported accordingly. Through calculating, a demagnetization curve with post-treatment for the magnet is obtained and displayed in the demagnetization curve displaying area.

### CROSS-REFERENCE TO RELATED APPLICATIONS

This is a continuation-in-part of parent patent application Ser. No. 16/100,838, filed on Aug. 10, 2018, which claims priority of Chinese patent application 201710681056.1, filed Aug. 10, 2017. The entire aforementioned application(s) are hereby incorporated herein by reference.

### BACKGROUND

### Technical Field

The present invention relates to the technical field of performance tests for magnet, in particular, to a system for evaluating ultimate demagnetization temperature of magnet.

### Related Art

The magnet of loudspeakers or the magnetic field of magnets is influenced greatly by temperature. The magnetic field intensity of NdFeB magnets may slow down with a rise in temperature, and the process is reversible. When the temperature reaches a certain ultimate demagnetization temperature, magnetic field intensity of NdFeB magnets may show a sharp decline, and even if the temperature turns back to room temperature, the magnetic field intensity cannot return to the previous strength. Such process is irreversible. Similarly, the magnetic field intensity of ferrite magnets may slow down with a decrease in temperature and the process is reversible. That is, when the temperature reaches a certain ultimate demagnetization temperature, irreversible demagnetization may emerge. In order to compute the demagnetization temperature of a loudspeaker and estimate the overall performance thereof, traditional calculating methods for ultimate demagnetization temperature of magnet may generally comprise the following three steps:

(1) Calculating the specific size of a magnetic loop system and using the formula

$$P c = \frac{L m A g σ}{A m L g f}$$

for loadline slope to estimate a corresponding magnetic flux leakage coefficient σ and a magnetoresistive coefficient f for calculating loadline slope Pc, wherein Lm is the thickness of the magnet, Am is the superficial area of the magnet, Ag is the superficial area of the magnetic gap, Lg is the thickness of the magnetic gap, σ is the magnetic flux leakage coefficient and f is the magnetoresistive coefficient. The loadline is determined by the size of the magnetic system. The slope of the load line helps determine the operation point of the magnet and further find the demagnetization temperature for the loudspeaker.
(2) Utilizing a graphic method to depict a loadline on the demagnetization curve provided by a magnet supplier, where the intersection point of the loadline and the demagnetization curve is the operation point of the magnet on this demagnetization curve under the corresponding temperature.
(3) It is necessary to find as many as possible demagnetization curves, in order to know the operating temperature of multiple temperatures, and when the operation point under a certain temperature overlaps with the knee point of the demagnetization curve, this temperature is the ultimate demagnetization temperature of magnet.

However, the above formulas for calculating loadline slope Pc in the traditional method for evaluating ultimate demagnetization temperature of magnet is not applicable to the opposite magnetic loop systems (or abnormal shape of magnetic loop systems) and the magnetic loop system of multiple magnets as such formulas introduce the magnetic flux leakage coefficient σ and magnetoresistive coefficient which are difficult to find out an accurate coefficient value, the computed Pc is led to be with errors. At the same time, since there are 3-5 demagnetization curves of different temperatures and the highest temperature therein is the operation temperature in magnet performance table, the final calculation is also difficult.

Thus, based on the above perspective views, there is an urgent technical need for quickly calculating the demagnetization temperature of magnet.

### SUMMARY

To solve the above problems in the prior art, the present invention provides a system for evaluating ultimate demagnetization temperature of magnet based on finite-element analysis (FEA) simulation of magnetic loop system. Through such system, an operation point at room temperature (20° C.) can be obtained and a value of loadline slope Pc can be further precisely obtained, and the ultimate demagnetization temperature of magnet in a loudspeaker system can be obtained accurately in the end by importing the to-be-solved variables and formulas into a FEA simulation through the temperature coefficient of magnet itself and, hence, by the solution and steady-state analysis using this system.

To achieve the above purpose, the present invention discloses a method for evaluating ultimate demagnetization temperature of a magnet in a loudspeaker system, comprising the following steps: providing a workspace interface; wherein the workspace interface at least includes an operation area a model view displaying area, and a demagnetization curve displaying area; loading a geometric model file of the loudspeaker system; wherein the geometric model file includes a plurality of part domains representing parts of the loudspeaker system, and at least one part domain represent the magnet of the loudspeaker system; displaying a geometric model view corresponding to the geometric model file in the model view displaying area; receiving information input through the operation area and the model view displaying area, and importing performance parameter and designing variables to be solved of the magnet of the loudspeaker system, and formulas, according to information input through the operation area and the model view displaying area; wherein the performance parameter of the magnet includes a magnetic remanence Br of magnet, a remanence tolerance DiffBr, a temperature coefficient of remanence α, an intrinsic coercivity Hcj of magnet, an intrinsic coercivity tolerance DiffHcj, a temperature coefficient of intrinsic coercivity β, a recoil permeability Pm of magnet and an inflection point gap parameter Xc; the remanence Br and intrinsic coercivity Hcj of magnet is measured at 20° C.; the variables to be solved include a coordinate (Hn, Bn) of the operation point under 20° C. on BH curve, a loadline slope (Pc, an ultimate temperature rise Tm and an ultimate demagnetization temperature Tlim; and the formulas include:

$$P c = \frac{B n}{H n} ;$$

$$Tm = \frac{B r - {( P c - P m )}^{*} ( H c j + X c )}{{( P c - P m )}^{*} H c {j}^{*} β - B {r}^{*} α} ;$$

$$T lim = Tm + 20 ;$$

establishing a finite element model for magnetic loop system according to the imported performance parameter of magnet, variables to be solved and formulas; calculating for a value of the coordinate (Hn, Bn) of the operation point under 20° C. on BH curve, the loadline slope Pc, and the ultimate demagnetization temperature Tlim through solving and conducting a steady-state analysis of the finite element model; obtaining a demagnetization curve with post-treatment for the magnet, and displaying the demagnetization curve in the demagnetization curve displaying area.

In at least one embodiment, receiving information input through the operation area and the model view displaying area comprises: arranging the operation area to include a soft iron core domain selection field, a magnet domain selection field, at least one material selection field, a voice coil domain selection field, a turns of the voice coil input field, and a start button; receiving, through the soft iron core domain selection field and the model view displaying area, a selection of a soft iron core domain corresponding to a soft iron core of the loudspeaker system; receiving, through the magnet domain selection field and the model view displaying area, a selection of magnet domain corresponding to the magnet of the loudspeaker system; receiving, through the at least one material selection field, a selection of at least one material of the magnet of the loudspeaker system; receiving, through the voice coil domain selection field and the model view displaying area, a selection of the voice coil domain corresponding to a voice coil of the loudspeaker system; receiving, through the voice coil domain selection field turns of the voice coil the loudspeaker system; and upon the start button being clicked, extracting the performance parameter and the designing variables to be solved, and formulas according to the information input through the operation area and the model view displaying area.

In at least one embodiment, the magnet domain selection field includes a main magnet domain selection field and a bucking magnet domain selection domain, the at least one material selection field includes a main magnet material selection field and a bucking magnet material selection field, and the magnet of the loudspeaker system includes a main magnet and a bucking magnet;

wherein receiving the selection of the at least one material of the magnet of the loudspeaker system includes:

receiving, through the main magnet domain selection field, a selection of a main magnet domain corresponding to the main magnet of the loudspeaker system; and

receiving, through the bucking magnet domain selection field, a selection of a bucking magnet domain corresponding to the bucking magnet of the loudspeaker system; and wherein receiving the selection of the at least one material of the magnet of the loudspeaker system includes: receiving, through the main magnet material selection field, a selection of a main magnet material of the magnet of the loudspeaker system; and receiving, through the bucking magnet material selection field, a selection of a bucking magnet material of the magnet of the loudspeaker system.

In at least one embodiment, the operation area further includes a checkbox for determining whether the main magnet and the bucking magnet are located two side of the voice coil.

In at least one embodiment, the demagnetization curve displaying area further includes a first demagnetization curve displaying sub-area and a second demagnetization curve displaying sub-area, the demagnetization curve includes a main magnet demagnetization curve corresponding to the main magnet and a bucking magnet demagnetization curve corresponding to the bucking magnet, and the main magnet demagnetization curve and the bucking magnet demagnetization curve are respectively displayed in the first demagnetization curve displaying sub-area and the second demagnetization curve displaying sub-area.

In at least one embodiment, the operation area further includes file selection field and a geometry input button, and loading a geometric model filed of a loudspeaker system includes: receiving, through the geometric model filed, a selection of the file selection field; and loading, upon the geometry input button being clicked, the geometric model file.

In at least one embodiment, the remanence of magnet under the ultimate demagnetization temperature Tlim is Br(Tlim)=Br+Br*α*Tm; the intrinsic coercivity of magnet under the ultimate demagnetization temperature Tlim is Hcj (Tlim)=Hcj+Hcj*β*Tm.

In at least one embodiment, the value of the inflection point gap parameter Xc is ranged from 300 to 1500.

In at least one embodiment, the magnetic loop system includes one of a 2D axisymmetric magnetic loop system, a non-2D axisymmetric magnetic loop system and a multi-magnetic-steel magnetic loop system.

In at least one embodiment, the magnet includes one of an NdFeB magnet and a ferrite magnet.

In at least one embodiment, a computer-readable storage medium stores instructions that, when executed by a computing system, cause the computing system to perform a process comprising the aforementioned steps of the method.

Based on above technical schemes, the beneficial effects provided by the present invention are as below:

(1) The method for evaluating ultimate demagnetization temperature of magnet provided by the present invention is based on FEA simulation of magnetic loop system. Through such method, the coordinate of an operation point at room temperature (20° C.) can be quickly found on BH curve and a value of loadline slope Pc can be further precisely obtained, and the ultimate demagnetization temperature of magnet in loudspeaker system can be obtained accurately in the end by importing the to-be-solved variables and formulas into FEA simulation through the temperature coefficient of magnet itself. After post-treatment in the end, a demagnetization curve for magnet is presented directly. This can provide overall information of demagnetization temperature for researches and users to enable to estimate effectively the overall performance of loudspeaker.

(2) The method for evaluating ultimate demagnetization temperature of magnet provided by the present invention can be suitable for calculating the ultimate demagnetization temperature of the magnet in any shape and structure and for calculating the ultimate demagnetization temperature of magnets with various demagnetization types, and is capable of quick solution to precisely obtain the ultimate demagnetization temperature of magnets. It has a wide range of application and an accurate and precise process of calculation.

### BRIEF DESCRIPTION OF THE DRAWINGS

This disclosure will become more fully understood from the detailed description given herein below for illustration only, and thus not limitative of this disclosure, wherein:

FIG. 1 is a block diagram of a computer system for executing the method for evaluating ultimate demagnetization temperature of magnet of the present invention;

FIG. 2 is flow chart for evaluating ultimate demagnetization temperature of magnet of the present invention;

FIG. 3 is a schematic view of a workspace interface of the present invention displayed by a display device;

FIG. 4 is a partial enlarged view of FIG. 3 illustrating the model view displaying area;

FIG. 5 is a partial enlarged view of FIG. 3 illustrating part of the operation area;

FIG. 6 is flow chart for receiving information input through the operation area and the model view displaying area;

FIG. 7 is a high temperature demagnetization curve view of the present invention;

FIG. 8 is a demagnetization curve of the present invention after post-treatment; and

FIG. 9 a schematic view of the workspace interface with demagnetization curves displayed thereon.

### DETAILED DESCRIPTION

To facilitate understanding, the invention will be described in detail in combination with drawings and the specific embodiments. The drawings illustrate preferred embodiments of the present invention. However, the present invention can be embodied in many different forms, and is not limited to the embodiments described herein. Rather, the purpose of providing these embodiments is to make the disclosure of the present invention more comprehensively understood.

Unless otherwise defined, all technical and scientific terms used herein have the same meaning as commonly understood by those skilled in the art to which this invention pertains. The terminology used herein in the specification of the present invention is for the purpose of describing particular embodiments only and is not intended to limit the invention.

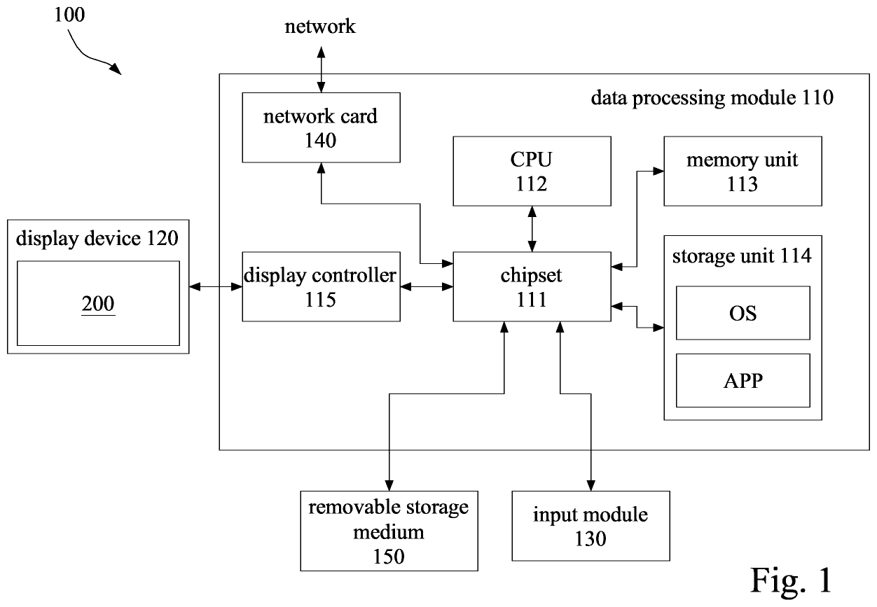

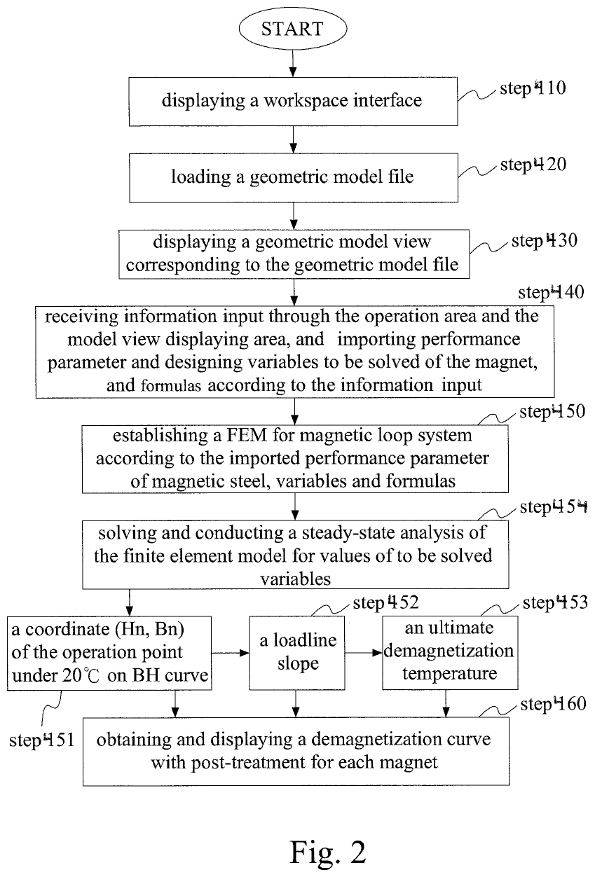

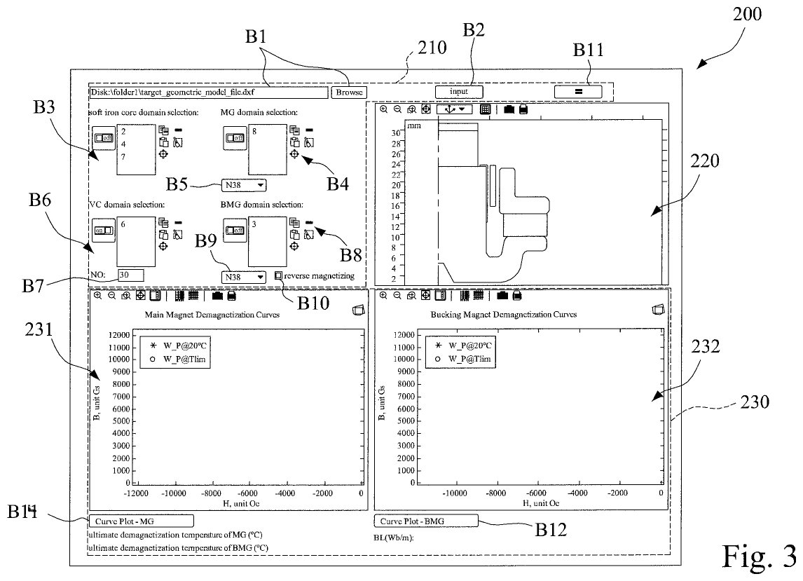

FIG. 1 illustrates a computer system 100 for evaluating ultimate demagnetization temperature of magnet according to an embodiment of the present invention. FIG. 2 illustrates a flow chart for evaluating ultimate demagnetization temperature of the magnet based on FEA simulation of magnetic loop system. FIG. 3 illustrates a workspace interface 200 displayed by the computer system 100. The computer system 100 may be a desktop system, a laptop system, a PAD system, a smartphone system, or the like.

As shown in FIG. 1, the computer system 100 reads computer-readable storage medium storing instructions and executes instructions, so as to perform a method for evaluating ultimate demagnetization temperature. The computer system 100 includes a data processing module 110, a display device 120, and an input module 130. The data processing unit module 110 further includes a chipset 111, a computer processing unit (CPU) 112, a memory unit 113, a storage unit 114, and a display controller 115. The CPU 112, the memory unit 113, the storage unit 114, and the display controller 115 are respectively connected the chipset 111, such that the CPU 112 is in communication with the memory unit 113, the storage unit 114, and the display controller 115 via the chipset 111. The storage unit 114 at least stores an operation system (OS) and evaluating program instructions (such as “APP”). After the computer system 100 completes a boot process by loading and executing the operation system (OS) from the storage unit 114, the CPU 112 further loads and executes the evaluating program instructions (APP) from the storage unit 114 automatically or on-demand.

As shown in FIG. 1, FIG. 2 and FIG. 3, after the computer system 100 loads and executes the evaluating program instructions (such as an APP or the like), the CPU 112 of computer system 100 drives the display device 120 through the display controller 115 to provide a workspace interface 200, as shown in Step 410. The workspace interface 200 includes an operation area 210, a model view displaying area 220, and a demagnetization curve displaying area 230. The demagnetization curve displaying area 230 may further includes a first demagnetization curve displaying sub-area 231 and a second demagnetization curve displaying sub-area 232.

Referring to FIG. 3, the operation area 210 includes, for example, a file selection field B 1, a geometry input button B2, a soft iron core domain selection field B3, a main magnet (MG) domain selection field B4, a MG material selection field B5, a voice coil (VC) domain selection field B6, a turns of the VC input field B7, a bucking magnet (BMG) domain selection field B8, a bucking magnet (BMG) material selection field B9, a checkbox for reverse magnetizing B10, and a start button B11.

Referring to FIG. 1, FIG. 2, and FIG. 3, automatically or on-demand, the system loads a geometric model file of a loudspeaker system, as shown in step 420.

In at least one embodiment, by using the input module 130, the user may, for example, select a geometric model file to be solved in a drop-down menu or a file browser provided within the file selection field B1, such that the computer system 100 receives a selection of the a geometric model file to be solved, and loads the geometric model file to be solved upon the geometry input button B2 being clicked. The geometric model file to be solved can be, but not limited to, loaded from a remote site on the network via a network card 140, the local storage unit 114, or a removable storage medium 150. The user may implement the selection by operating the input module 130, and the input module 130 can be, but not limited to a keyboard, a mouse, or a touch control panel combined with the display device 120. Next, by using the input module 130, the user clicks the geometry input button B2, for example, and then the system loads the geometric model file to be solved.

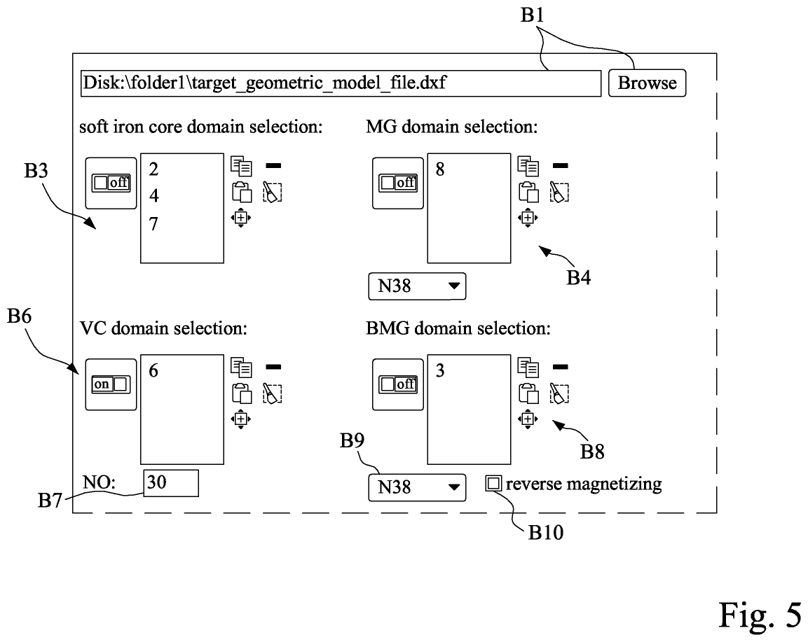

As shown in FIG. 5, the geometric model file includes plural part domains representing parts of the loudspeaker system. The geometric model file is a 2D or 3D geometric model file, for example a DXF file. In a 2D geometric model file, each of the part domains is defined by a closed loop contour line. In a 3D geometric model file, each of the part domains is an independent part defined in the 3D geometric model file.

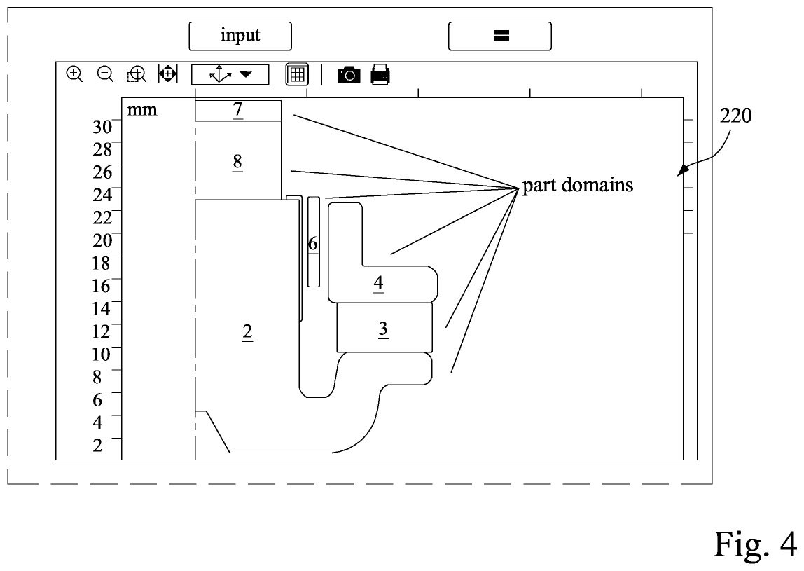

As shown in FIG. 2, FIG. 3 and FIG. 4., the computer system 100 parses the geometric model file, to drive the display device 120 to display a geometric model view corresponding to the geometric model file in the model view displaying area 220, as shown in step 430. And then the computer system 100 receives information input through the operation area 210 and the model view displaying area 220, and imports performance parameter and designing variables of the parts of the loudspeaker system from the operation area 210, as shown in step 440.

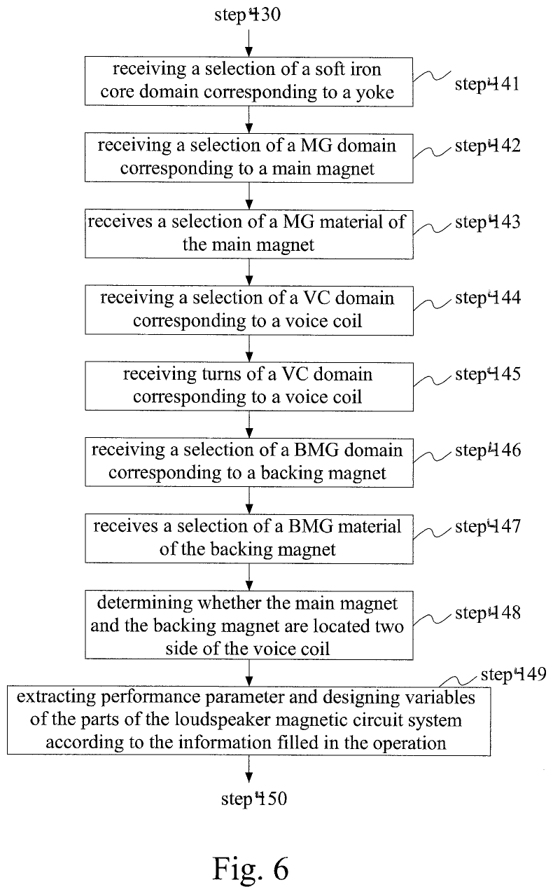

As shown in FIG. 4, FIG. 5 and FIG. 6, details of step 440 are described hereinafter. By using the input module 130, the user clicks on the soft iron core domain selection field B3, for example, and then selects a soft iron core domain in the geometric model view displayed in the model view displaying area 220, such that the computer system 100 receives a selection of the soft iron core domain (for example, by clicking on section No. 2, 4, 7 in FIG. 4 and FIG. 5) corresponding to a soft iron core of the loudspeaker system, as shown in step 441.

By using the input module 130, the user clicks on the MG domain selection field B4, for example, and then selects an MG domain in the geometric model view displayed in the model view displaying area 220, such that the computer system 100 receives a selection of the MG domain (for example, by clicking on section No. 8 in FIG. 4 and FIG. 5) corresponding to a main magnet of the loudspeaker system, as shown in step 442.

By using the input module 130, the user selects a material of the main magnet by click MG material selection field B5 (usually a drop-down menu), for example, such that the computer system 100 receives a selection of a MG material of the main magnet of the loudspeaker system, as shown in step 443.

By using the input module 130, the user clicks on the VC domain selection field B6, for example, and then selects a VC domain in the geometric model view displayed in the model view displaying area 220, such that the computer system 100 receives a selection of the VC domain (for example, by clicking on section No. 3 in FIG. 4 and FIG. 5) corresponding to a voice coil of the loudspeaker system, as shown in step 444.

By using the input module 130, the user input turns of the VC in to the input field B7, for example, such that the computer system 100 receives the turns of the voice coil the loudspeaker system, as shown in step 445.

By using the input module 130, the user clicks on the BMG domain selection field B8, and then selects a BMG domain in the geometric model view displayed in the model view displaying area 220, such that the computer system 100 receives a selection of the BMG domain (for example, by clicking on section No. 3 in FIG. 4 and FIG. 5) corresponding to a bucking magnet of the loudspeaker system, as shown in step 146.

By using the input module 130, the user selects a material of the bucking magnet by click BMG material selection field B9 (usually a drop-down menu), such that the computer system 100 receives a selection of a BMG material of the bucking magnet of the loudspeaker system, as shown in step 447.

By using the input module 130, the user clicks the checkbox for reverse magnetizing B10 to check or uncheck the checkbox, such that the computer system 100 determines whether the main magnet and the bucking magnet are located two side of the voice coil, as shown in step 448.

Referring to FIG. 4, FIG. 5 and FIG. 6 again, for example, if the loudspeaker system has only one magnet, that is, the loudspeaker system includes a main magnet and is not equipped with bucking magnet, the user may select the air domain in the geometric model view for step 446 and select “NONE” for step 447.

Furthermore, by using the input module 130, the user clicks the start button B11, the performance parameter and the designing variables to be solved, and formulas are extracted by the computer system 100 according to the information input through the operation area 210 and the model view displaying area 220, as shown in step 449. Then the performance parameter and the designing variables (e.g., Pc, Tm, Tlim, etc.) are solved and formulas are imported.

As shown in FIG. 2, next, in step 450 the computer system 100 establishes a finite element model (FEM) for magnetic loop system according to the performance parameter of magnet, variables and formulas in step 440/449.

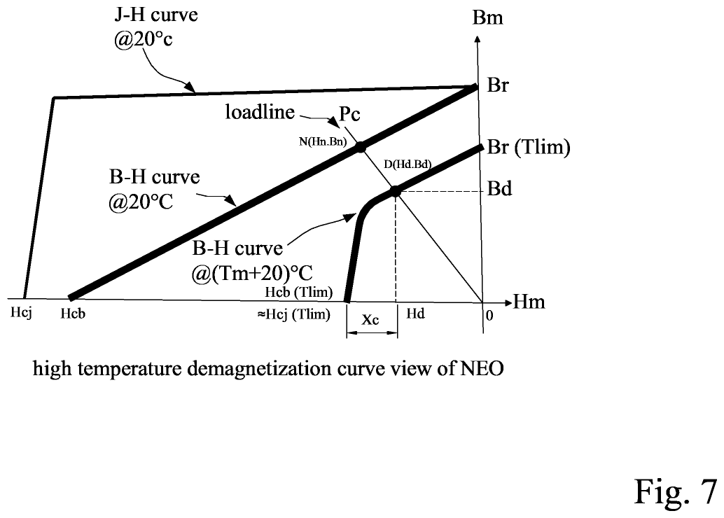

As shown in FIG. 2 and FIG. 7, the computer system 100 calculates for a value of the coordinate (Hn, Bn) of the operation point under 20° C. on a BH curve, the loadline slope Pc, and the ultimate demagnetization temperature Tlim through solving and conducting a steady-state analysis of the finite element model for each magnet (main magnet and bucking magnet), as shown in step 454, step 451, step 452 and step 453.

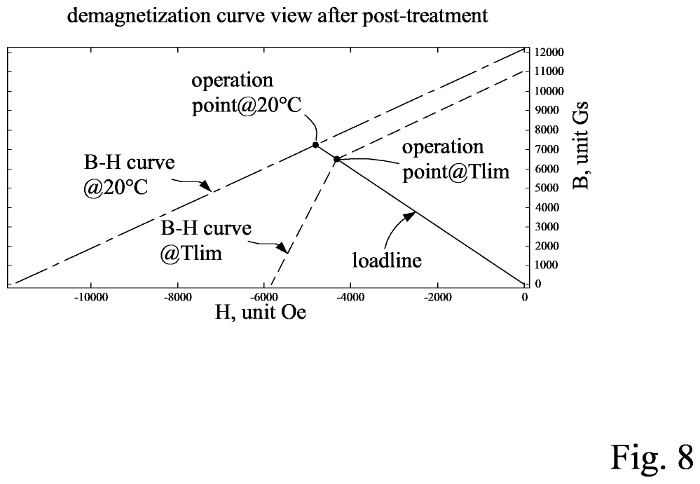

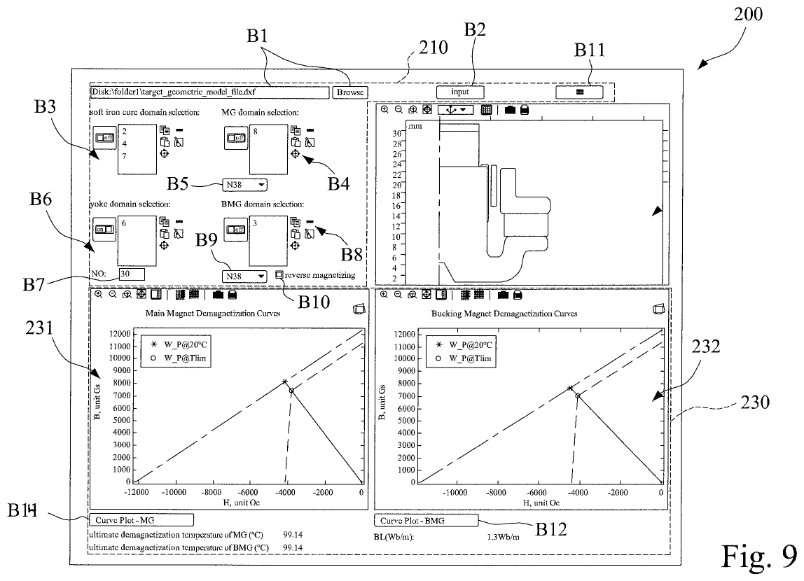

As shown in FIG. 2, FIG. 8 and FIG. 9, the computer system 100 obtains and displays a demagnetization curve with post-treatment for each magnet, as shown in step 160.

Please referring to FIG. 2, FIG. 8 and FIG. 9, in step 160, the user may clicks curve plot buttons B14 and B12, to activate the computer system 100 to display the main magnet demagnetization curve and the bucking magnet demagnetization curve in the first demagnetization curve displaying sub-area 231 and the second demagnetization curve displaying sub-area 232 respectively. The thermal demagnetization simulation may be displayed properly.

The performance parameter of the magnet may be stored in a database, which includes a magnetic remanence Br of magnet, a remanence tolerance DiffBr, a temperature coefficient of remanence α, an intrinsic coercivity Hcj of magnet, an intrinsic coercivity tolerance DiffHcj, a temperature coefficient of intrinsic coercivity β, a recoil permeability Pm of magnet and an inflection point gap parameter Xc.

In the present embodiment, the room temperature is considered to be 20° C. The above remanence Br and intrinsic coercivity Hcj of magnet is measured at 20° C.

The above variables designed to be solved include a coordinate (Hn, Bn) of the operation point N under room temperature on BH curve, a loadline slope Pc, an ultimate temperature rise Tm and an ultimate demagnetization temperature Tlim.

In the method for evaluating ultimate demagnetization temperature of magnet of the present invention, solving the variables is key to the present invention. In order to better understand the performance parameter of magnet and the to-be-solved variables, FIG. 7 illustrates a high temperature demagnetization curve of one of the magnets for NEO of the present invention. With reference to FIG. 2, on the high temperature demagnetization curve, vertical coordinate Bm represents the magnetic flux density inside the magnet, which is a positive value; horizontal coordinate Hm represents the magnetic field intensity inside the magnet, which is a negative value; B-H curve@20° C. represents the B-H curve under 20° C. (room temperature), the intersection point of B-H curve@20° C. and the vertical coordinate is remanence Br of the magnet under 20° C. and the intersection point B-H curve@20° C. and the horizontal coordinate is coercivity Hcb of the magnet under 20° C. J-H curve@20° C. represents J-H curve under 20, and the intersection point of J-H curve@20° C. and the horizontal coordinate is intrinsic coercivity Hcj of the magnet under 20° C.

B-H curve@ (Tm+20)° C. represents B-H curve under ultimate demagnetization temperature; the intersection point of B-H curve@ (Tm+20)° C. and the vertical coordinate is remanence Br Tlim of the magnet under ultimate demagnetization temperature and the intersection point of B-H curve@ (Tm+20)° C. and the horizontal coordinate is coercivity Hcj(Tlim) of the magnet under ultimate demagnetization temperature, here coercivity Hcb(Tlim) is about equal to intrinsic coercivity Hcj(Tlim).

When in 20° C. of room temperature, the difference between intrinsic coercivity Hcj and coercivity Hcb is larger and Hcb>Hcj; with the rise of temperature, both Hcj and Hcb becomes larger gradually, but Hcj changes so fast that it gradually closes to Hcb.

Since coercivity Hcb(Tlim) is about equal to intrinsic coercivity Hcj(Tlim) on B-H curve@ (Tm+20)° C., an inflection point occurs on B-H curve@ (Tm+20)° C.

Pc is loadline slope, which may not change with the temperature; the intersection of loadline and B-H curve@20° C. is the operation point N of magnet with a coordinate of (Hn, Bn).

B-H curves of magnet under different temperatures are different, i.e., the operation points are different, but the slope of loadline remains consistent. Pm is recoil permeability of magnet, which also doesn't change with the temperature.

Xc is inflection point gap parameter. With a further reference to FIG. 7, Xc also represents the difference on X axis between the inflection point and Hcb(Tlim) on B-H curve under ultimate demagnetization temperature Tlim, the value being ranged from 300 to 1500 Oe. The value range of inflection point gap parameter Xc is obtained with a preferential selection by the researchers in experiments. Through researches and comparison, the researchers found that if Xc is not introduced, the Tm obtained by calculation is larger than actual value, i.e., introduction of inflection point gap parameter Xc during calculation and measurement can calculate to obtain the ultimate temperature rise Tm with more accuracy.

Furthermore, since an intrinsic coercivity Hcj, an intrinsic coercivity tolerance DiffHcj, and an inflection point gap parameter Xc are introduced in the present embodiment, a demagnetization temperature region can be confirmed after adjustment of the value of Xc based on the validation test result.

In addition, for NdFeB magnets after high temperature demagnetization, both the temperature coefficient α of the remanence and temperature coefficient β of intrinsic coercivity are negative values. Additionally, for ferrite magnets after low temperature demagnetization, the temperature coefficient α of the remanence thereof is a negative value; temperature coefficient β of intrinsic coercivity is a positive value.

Based on remanence Br, intrinsic coercivity Hcj, temperature coefficient of remanence α, temperature coefficient of intrinsic coercivity β and ultimate temperature rise, it can be acquired that: the remanence of magnet under the ultimate demagnetization temperature Tlim is Br(Tlim)=Br+Br*α*Tm; and the intrinsic coercivity of magnet under the ultimate demagnetization temperature Tlim is Hcj (Tlim)=Hcj+Hcj*β*Tm.

The intersection of loadline and B-H curve@(Tm+20)° C. is the operation point D of magnet under such temperature with a coordinate of (Hd, Bd).

Further, based on above performance parameter of magnet and to-be-solved variables, it can be deduced with relative formulas according to the principle of demagnetization that:

$$P c = \frac{B d}{H d} = \frac{B n}{H n} ;$$

$$Tm = \frac{B r - {( P c - P m )}^{*} ( H c j + X c )}{{( P c - P m )}^{*} H c {j}^{*} β - B {r}^{*} α} ;$$

$$T lim = Tm + 20 ;$$

Ordinary magnetic loop system simulation only focuses on the B value among magnetic gaps, so only the remanence parameter Br of magnet is needed to be imported. But now solving the ultimate demagnetization temperature needs an overall FEA simulation for the magnetic loop system, wherein more performance parameters of magnet are imported to conduct variable-solution and steady-state analysis for a quick solution to obtain a coordinate (Hn, Bn) of operation point N at room temperature (20° C.) on BH curve and a loadline slope Pc, thus obtaining an ultimate demagnetization temperature Tlim after further solution.

In the present embodiment, values for the imported performance parameter of magnet are shown in Table 1 as below:

TABLE 1
Imparted performance parameter of magnet (@ 20° C.) and
specific values:

| Name for performance | | |
|---|---|---|
| parameter of magnet | Value | Description |
| Br | 12200 | Remanence of magnet, Gs |
| DiffBr | 200 | Remanence tolerance, Gs |
| Hcj | −14000 | Intrinsic coercivity of magnet, Oe |
| DiffHcj | 300 | Intrinsic coercivity tolerance, Oe |
| β | −0.0063 | Temperature coefficient of intrinsic |
| | | coercivity |
| α | −0.0012 | Temperature coefficient of |
| | | remanence |
| Xc | 800 | Inflection point gap parameter. |
| Pm | 1.05 | Recoil permeability of magnet |

The above performance parameters of magnet and variables designed to be solved are imported into COMSOL Multiphysics software and a finite element model for magnetic loop system is established; then a solution and a steady-state analysis on the finite element model are conducted for values of variables that are to be solved, then a coordinate (Hn, Bn), a loadline slope Pc value and an ultimate demagnetization temperature value of the operation point under 20° C. on BH curve are obtained after calculation. Then after a series of post-treatments (i.e., data handling for the simulated result and combining the initial data to output figures for improved understanding for technicians):

(1) Coordinate (Hn, Bn) of operation point N at 20° C. room temperature is imported, the line connecting the coordinate origin of demagnetization curve (with the operation point N being the loadline;

(2) BH curve at 20° C. room temperature is imported, i.e., the line connecting (0, Br) with (Hcj, 0) is imported;

(3) BH curve at ultimate demagnetization temperature) Tlim is imported, i.e. The line connecting (0, Br(Tlim)), (Hd, Bd) and (Hcj(Tlim), 0). Among which:

the remanence of magnet under the ultimate demagnetization temperature Tlim is Br(Tlim)=Br+Br*α*Tm;

the intrinsic coercivity of magnet under the ultimate demagnetization temperature) Tlim is Hcj (Tlim)=Hcj+Hcj*β*Tm;

the horizontal coordinate of operation point at ultimate demagnetization temperature Tlim: Hd=Hcj+Hcj*β*Tm+Xc; the vertical coordinate of operation point at ultimate demagnetization temperature Tlim: Bd=(Br+Br*α*Tm)+(Hcj+Hcj*β*Tm+Xc)*Pm.

After above post-treatments, a treated demagnetization curve shown in FIG. 8 and FIG. 9 is presented directly. This can provide overall information of demagnetization temperature for researches and users to enable to estimate effectively the overall performance of loudspeaker.

The method for evaluating ultimate demagnetization temperature of loudspeaker magnet provided by the present invention can be suitable for calculating the ultimate demagnetization temperature of loudspeaker magnet in any shape and structure, including 2D axisymmetric magnetic loop system, a non-2D axisymmetric magnetic loop system and a multi-magnetic-steel magnetic loop system, thereby solving the problem that traditional method for evaluating ultimate demagnetization temperature of loudspeaker magnet cannot be suitable for the opposite magnetic loop system and magnetic loop system of multiple magnets.

The computer system 100 for evaluating ultimate demagnetization temperature of loudspeaker magnet provided by the present embodiment can be suitable for evaluating the ultimate demagnetization temperature of loudspeaker magnet in various types of demagnetization, which includes the temperature demagnetization of NEO (NdFeB magnet) and the temperature demagnetization of ferrite magnet. This calculation method does not need to introduce the magnetic flux leakage coefficient σ and magnetoresistive coefficient f and also to draw multiple demagnetization curve s at different temperatures. This calculating method is quick in calculation, rapid and has a high effectiveness.

The foregoing is merely illustrative and illustrative of the structure of the invention, and the description thereof is more specific and detailed, but is not to be construed as limiting the scope of the invention. It should be noted that various modifications and improvements can be made by those skilled in the art without departing from the spirit of the invention, and these obvious alternatives are within the scope of the present invention.

What is claimed is:

1. A method for evaluating ultimate demagnetization temperature of a magnet in a loudspeaker system, comprising:
providing a workspace interface;
receiving information input through the workspace interface so as to import a corresponding performance parameter of the magnet;
establishing a finite element model according to the imported performance parameter of the magnet;
calculating a BH curve, a loadline slope, and an ultimate demagnetization temperature according to the finite element model; and
obtaining a demagnetization curve of the magnet based on the calculated BH curve, the loadline slope, and the ultimate demagnetization temperature.

2. The method for evaluating ultimate demagnetization temperature of a magnet as claimed in claim 1, further comprising loading a geometric model file of the loudspeaker system,
wherein the geometric model file includes a plurality of part domains representing parts of the loudspeaker system, and at least one part domain represent the magnet of the loudspeaker system.

3. The method for evaluating ultimate demagnetization temperature of a magnet as claimed in claim 2, further comprising displaying a geometric model view corresponding to the geometric model file in the model view displaying area.

4. The method for evaluating ultimate demagnetization temperature of a magnet as claimed in claim 3, further comprising designing formulas and variables to be solved for the magnet of the loudspeaker system according to information input through the workspace interface,
wherein the performance parameter of the magnet includes a magnetic remanence Br of magnet, a remanence tolerance DiffBr, a temperature coefficient of remanence α, an intrinsic coercivity Hcj of magnet, an intrinsic coercivity tolerance DiffHcj, a temperature coefficient of intrinsic coercivity β, a recoil permeability Pm of magnet and an inflection point gap parameter Xc,
wherein the remanence Br and intrinsic coercivity Hcj of magnet is measured at 20° C.,
wherein the variables to be solved include a coordinate (Hn, Bn) of the operation point under 20° C. on the BH curve, the loadline slope (Pc), the ultimate temperature rise Tm and the ultimate demagnetization temperature Tlim, and
wherein the formulas include:
$$P c = \frac{B n}{H n} ;$$
$$Tm = \frac{B r - {( P c - P m )}^{*} ( H c j + X c )}{{( P c - P m )}^{*} H c {j}^{*} β - B {r}^{*} α} ;$$
$$T lim = Tm + 20 ;$$
obtaining a demagnetization curve with post-treatment for the magnet, and displaying the demagnetization curve in the demagnetization curve displaying area.

5. The method for evaluating ultimate demagnetization temperature of a magnet as claimed in claim 1, wherein the workspace interface comprises:
an operation area; and
a demagnetization curve displaying area,
wherein the operation area comprises:
a soft iron core domain selection field; a magnet domain selection field;
at least one material selection field;
a voice coil domain selection field;
a turns of the voice coil input field; and
a start button, and
wherein receiving information input through workspace interface comprises:
receiving, through the soft iron core domain selection field and the model view displaying area, a selection of a soft iron core domain corresponding to a soft iron core of the loudspeaker system;
receiving, through the magnet domain selection field and the model view displaying area, a selection of the magnet domain corresponding to the magnet of the loudspeaker system;
receiving, through the at least one material selection field, a selection of at least one material of the magnet of the loudspeaker system;
receiving, through the voice coil domain selection field and the model view displaying area, a selection of the voice coil domain corresponding to a voice coil of the loudspeaker system;
receiving, through the voice coil domain selection field turns of the voice coil the loudspeaker system; and
upon the start button being clicked, extracting the performance parameter and the designing variables to be solved, and formulas according to the information input through the operation area and the model view displaying area.

6. The method for evaluating ultimate demagnetization temperature of a magnet as claimed in claim 5, wherein the magnet domain selection field comprises:
a main magnet domain selection field; and
a bucking magnet domain selection domain,
wherein the at least one material selection field comprises:
a main magnet material selection field; and
a bucking magnet material selection field, and
wherein the magnet of the loudspeaker system comprises:
a main magnet; and
a bucking magnet,
wherein receiving the selection of the at least one material of the magnet of the loudspeaker system includes:
receiving, through the main magnet domain selection field, a selection of a main magnet domain corresponding to the main magnet of the loudspeaker system; and
receiving, through the bucking magnet domain selection field, a selection of a bucking magnet domain corresponding to the bucking magnet of the loudspeaker system, and
wherein receiving the selection of the at least one material of the magnet of the loudspeaker system includes:
receiving, through the main magnet material selection field, a selection of a main magnet material of the magnet of the loudspeaker system; and
receiving, through the bucking magnet material selection field, a selection of a bucking magnet material of the magnet of the loudspeaker system.

7. The method for evaluating ultimate demagnetization temperature of a magnet as claimed in claim 6, wherein the operation area further includes a checkbox for determining whether the main magnet and the bucking magnet are located two side of the voice coil.

8. The method for evaluating ultimate demagnetization temperature of a magnet as claimed in claim 6, wherein the demagnetization curve displaying area further comprises:
a first demagnetization curve displaying sub-area; and
a second demagnetization curve displaying sub-area,
wherein the demagnetization curve comprises:
a main magnet demagnetization curve corresponding to the main magnet; and
a bucking magnet demagnetization curve corresponding to the bucking magnet, and
wherein the main magnet demagnetization curve and the bucking magnet demagnetization curve are respectively displayed in the first demagnetization curve displaying sub-area and the second demagnetization curve displaying sub-area.

9. The method for evaluating ultimate demagnetization temperature of a magnet as claimed in claim 5, wherein the operation area further comprises:
a file selection field; and
a geometry input button, and
wherein loading a geometric model filed of a loudspeaker system includes:
receiving, through the geometric model filed, a selection of the file selection field; and
loading, upon the geometry input button being clicked, the geometric model file.

10. The method for evaluating ultimate demagnetization temperature of magnet as claimed in claim 4, wherein the remanence of magnet under the ultimate demagnetization temperature Tlim is Br(Tlim)=Br+Br*α*Tm; the intrinsic coercivity of magnet under the ultimate demagnetization temperature Tlim is Hcj (Tlim)=Hcj+Hcj*β*Tm.

11. The method for evaluating ultimate demagnetization temperature of magnet as claimed in claim 4, wherein the value of the inflection point gap parameter Xc is in a range from 300 to 1500.

12. The method for evaluating ultimate demagnetization temperature of magnet as claimed in claim 1, wherein the finite element model is provided for a magnetic loop system including a 2D axisymmetric magnetic loop system, a non-2D axisymmetric magnetic loop system, or a multi-magnetic-steel magnetic loop system.

13. The method for evaluating ultimate demagnetization temperature of magnet as claimed in claim 1, wherein the magnet includes an NdFeB magnet or a ferrite magnet.

14. A computer-readable storage medium storing instructions that, when executed by a computing system, cause the computing system to perform a process comprising:
providing a workspace interface;
receiving information input through the workspace interface so as to import corresponding performance parameter of the magnet;
establishing a finite element model according to the imported performance parameter of the magnet;
calculating for a BH curve, a loadline slope, and an ultimate demagnetization temperature according to the finite element model; and
obtaining a demagnetization curve of the magnet based on the calculated BH curve, the loadline slope, and the ultimate demagnetization temperature.

15. The computer-readable storage medium claimed in claim 14, the process further comprising loading a geometric model file of a loudspeaker system,
wherein the geometric model file includes a plurality of part domains representing parts of the loudspeaker system, and at least one part domain represent the magnet of the loudspeaker system.

16. The computer-readable storage medium claimed in claim 15, the process further comprising displaying a geometric model view corresponding to the geometric model file in the model view displaying area.

17. The computer-readable storage medium claimed in claim 16, the process further comprising designing formulas and variables to be solved for the magnet of the loudspeaker system according to information input through the workspace interface,
wherein the performance parameter of the magnet includes a magnetic remanence Br of magnet, a remanence tolerance DiffBr, a temperature coefficient of remanence α, an intrinsic coercivity Hcj of magnet, an intrinsic coercivity tolerance DiffHcj, a temperature coefficient of intrinsic coercivity β, a recoil permeability Pm of magnet and an inflection point gap parameter Xc,
wherein the remanence Br and intrinsic coercivity Hcj of magnet is measured at 20° C.,
wherein the variables to be solved include a coordinate (Hn, Bn) of the operation point under 20° C. on the BH curve, the loadline slope (Pc), the ultimate temperature rise Tm and the ultimate demagnetization temperature Tlim, and
wherein the formulas include:
$$P c = \frac{B n}{H n} ;$$
$$Tm = \frac{B r - {( P c - P m )}^{*} ( H c j + X c )}{{( P c - P m )}^{*} H c {j}^{*} β - B {r}^{*} α} ;$$
$$T lim = Tm + 20 ;$$
obtaining a demagnetization curve with post-treatment for the magnet, and displaying the demagnetization curve in the demagnetization curve displaying area.

18. The computer-readable storage medium claimed in claim 14, wherein the workspace interface includes an operation area and a demagnetization curve displaying area,
wherein the operation area includes a soft iron core domain selection field, magnet domain selection field, at least one material selection field, a voice coil domain selection field, a turns of the voice coil input field, and a start button, and
wherein receiving information input through workspace interface comprises:
receiving, through the soft iron core domain selection field and the model view displaying area, a selection of a soft iron core domain corresponding to a soft iron core of the loudspeaker system;
receiving, through the magnet domain selection field and the model view displaying area, a selection of magnet domain corresponding to the magnet of the loudspeaker system;
receiving, through the at least one material selection field, a selection of at least one material of the magnet of the loudspeaker system;
receiving, through the voice coil domain selection field and the model view displaying area, a selection of the voice coil domain corresponding to a voice coil of the loudspeaker system;
receiving, through the voice coil domain selection field turns of the voice coil the loudspeaker system; and
upon the start button being clicked, extracting the performance parameter and the designing variables to be solved, and formulas according to the information input through the operation area and the model view displaying area.

19. The computer-readable storage medium claimed in claim 18, wherein the magnet domain selection field comprises:
a main magnet domain selection field; and
a bucking magnet domain selection domain,
wherein the at least one material selection field comprises:
a main magnet material selection field; and
a bucking magnet material selection field, and
wherein the magnet of the loudspeaker system includes a main magnet and a bucking magnet,
wherein receiving the selection of the at least one material of the magnet of the loudspeaker system comprises:
receiving, through the main magnet domain selection field, a selection of a main magnet domain corresponding to the main magnet of the loudspeaker system; and
receiving, through the bucking magnet domain selection field, a selection of a bucking magnet domain corresponding to the bucking magnet of the loudspeaker system; and
wherein receiving the selection of the at least one material of the magnet of the loudspeaker system comprises:
receiving, through the main magnet material selection field, a selection of a main magnet material of the magnet of the loudspeaker system; and
receiving, through the bucking magnet material selection field, a selection of a bucking magnet material of the magnet of the loudspeaker system.

20. The computer-readable storage medium claimed in claim 18, wherein the demagnetization curve displaying area further comprises:
a first demagnetization curve displaying sub-area; and
a second demagnetization curve displaying sub-area,
wherein the demagnetization curve comprises:
a main magnet demagnetization curve corresponding to the main magnet; and
a bucking magnet demagnetization curve corresponding to the bucking magnet, and
wherein the main magnet demagnetization curve and the bucking magnet demagnetization curve are respectively displayed in the first demagnetization curve displaying sub-area and the second demagnetization curve displaying sub-area.
